(19) United States
(12) Patent Application Publication
(10) Pub. No.: US 2005/0018896 A1
(43) Pub. Date: Jan. 27, 2005

(54) System and method for verifying legibility of an image of a check

(75) Inventors: Graham Heit, Waterloo (CA); Doug Newman, Elora (CA); Peter Hanna, Waterloo (CA)

Correspondence Address: VALENTINE A. COTTRILL, SUITE 1020 50 QUEEN STREET NORTH, KITCHENER, ON, N2H6M2, CA

(73) Assignee: RDM Corporation, Waterloo (CA)

(21) Appl. No.: 10/895,834

(22) Filed: Jul. 22, 2004

Related U.S. Application Data
(60) Provisional application No. 60/488,782, filed on Jul. 22, 2003.

(51) Int. Cl. G06K 9/00

(52) U.S. Cl. 382/137

(57) ABSTRACT

A method for verifying legibility of an image of a check captured in digital image data, the check having two groups of characters on a front side thereof. Each group includes characters which are numeric representations. The characters in one group have a predetermined relationship to the characters in another group. Each said group is spaced apart from each other and located in a preselected pattern. The method includes the steps of extracting images of each said group from the digital image data, recognizing the images to provide image values of the characters, performing operations on certain image values for one group in accordance with the relationship to provide calculated values, and comparing the image values for another group with the calculated values. If the image and calculated values are not identical, a warning signal is generated.

### FIELD OF THE INVENTION

This invention is related to a system and a method for verifying legibility of an image of a check captured in digital image data.

### BACKGROUND OF THE INVENTION

In retail merchant cashier and check-out applications, small and relatively inexpensive bank check readers which capture MICR (magnetic ink character recognition) data and digital image files are commonly used for processing checks. The MICR code line is read by a MICR reader, and the digital image files are created by an optical scanner as the paper check passes through the device. These devices, typically peripherals to a personal computer, are often used in a relatively new process known as check conversion and truncation. In check conversion and truncation, the merchant uses the check reader to create a MICR and digital image file, converts the check to an electronic payment in accordance with NACHA (National Automated Clearing House Association) rules, and then returns the check document directly to the consumer at the point of sale. The MICR data is used to effect the transfer of funds, and the image file is archived to use for future visual reference if the transfer of funds fails for any reason. Typical reasons for such failure would include non-sufficient funds (“NSF”) or administrative error.

In such retail transactions, the digital image files which are captured must be of high quality. Specifically, in order to be useful, they must be “human readable”, meaning that characters in each image created from such digital image file are legible to a human being, substantially to the extent that such characters are legible in the original paper check.

Similarly, banks capture check image files for various check processing purposes, including the replacement of microfilm. In the United States, bank deposit check processing will be subject to legislation (known as “Check 21”, a 2003 Act of Congress, to be effective in October 2004), which provides a legal framework for recognition of an image of a check document. The legislation would provide that, as a substitute for the original check document, an image replacement document (“IRD”) can be printed from the image file and used as a substitute, for legal purposes, for the original paper check document. This is useful where, for example, satisfactory evidence of the paper check document is required at a remote location, for example, to complete a transaction or to prove that a transaction took place. As in the retail check truncation environment, the image file must be IRD worthy, that is, printable as a legible IRD, i.e., “human readable” and compatible with the United States check processing system. It is contemplated that, under Check 21, a financial institution would destroy paper checks after images thereof are captured, to avoid the expense of storing the paper checks.

It can therefore be seen that, under Check 21, there will be a need to verify that the captured image of a check is human readable. As in the retail environment, this need arises because the check processing procedure to be followed contemplates that, at a time shortly after the check is scanned by an image scanner, the paper check will not be available.

A line of typical MICR characters 10 is shown on a front side 12 of a typical exemplary check 14 in FIGS. 1A and 1B. The MICR line 10 is determined by the drawee financial institution, i.e., the financial institution on which the check is to be drawn, but is consistent with the standards and requirements of The American National Standard for Financial Service X9.13, Placement and Location of Magnetic Ink Printing (MICR).

The check 14 is compatible with the United States check processing system, and in particular, it is a sample of a personal check for use in the U.S. Although other types of checks (e.g., a business check compatible with the U.S. check processing system) differ somewhat from the check 14 shown in FIGS. 1A and 1B, for simplicity, only the sample check 14 will be discussed in detail. Other types of checks are also subject to standards and conventions similar to those described below in connection with the sample check 14.

The front side 12 of the cheque 14 as shown in FIG. 1A includes a background coloring 15. For clarity, the front side 12 of the check 14 is shown in FIG. 1B without the background coloring 15 and drawn at a larger scale.

The MICR line 10 includes a field of MICR characters 16. As can be seen in FIG. 1B, the field of MICR characters 16 (usually referred to as a “transit routing field”) is located on the front side 12, near a left-hand edge 17 of the check 14, and also adjacent to a bottom edge 18 thereof.

In addition, the MICR line 10 includes an “on-us” field of MICR characters 19, in which a sub-field of MICR characters 20 specifying the account on which the check 14 is drawn is located. The MICR characters in the field 19 are determined in accordance with ANSI X9.13 and, usually, also in accordance with the drawee financial institution's internal rules regarding account numbers and check digit verification techniques. The field of MICR characters 19 also includes a sub-field of MICR characters 21 which provides a check serial number, i.e., a serial number for the check 14.

Typically, and as shown in FIGS. 1A and 1B, the front side 12 of the check 14 also includes certain non-MICR printed characters. The non-MICR printed characters include information which is related to certain information included in certain fields in the MICR line 10, and certain of the non-MICR printed characters replicate certain information found in the MICR line 10. By convention, the non-MICR printed characters are located in a preselected pattern on the front side 12 and in an upper right-hand corner thereof, spaced apart from the MICR line 10.

For example, a field of non-MICR printed character 23 (typically referred to as “fractional FR-ABA data”) is positioned near a right-hand edge 24 of the check 14, adjacent to a space provided for the date of the check 14. Also, and as shown in FIG. 1B, a field of non-MICR printed characters 26 which also includes the check serial number is located adjacent to the right-hand edge 24 and a top edge 28 of the check 14.

The front side 12 of the check 14 also includes handwritten data, such as a date 30, an amount 32, and a payee 34.

In practice, a digital image file provided by an image scanner may be defective for a variety of reasons. For instance, the image scanner may malfunction, and the malfunction may not be detected. Or the check 14 may be partly folded over or bent, to obscure at least some of the MICR or non-MICR printed characters, or handwritten data.

Also, the background on the front side of a check can have relatively dark areas (i.e., the background) on which the MICR line 10 or the non-MICR printed character fields 23 and/or 26, or handwritten data (or parts thereof) are located, possibly resulting in a partially illegible image due to poor contrast.

The problem of ensuring “image readiness” of the handwritten data (i.e., the date 30, the amount 32, and the payee 34) and the non-MICR printed characters (i.e., those in the fields 23 and 26) in the upper regions of the check where the background provides poor contrast is generally considered to be the most significant of the problems in this area. The background on the check can cause background clutter, illegibility and ambiguity in binary images. Because dark background coloring is usually not present in the vicinity of the MICR code line 10, the problem of poor contrast does not usually affect the MICR line 10.

From the foregoing, it can be seen that a failure to capture an image which will be human readable can have serious consequences, both in the retail environment and under Check 21. Ideally, one would prefer to determine whether a human readable image has been captured at a point when one can, if necessary, make a second attempt to capture a human readable image, i.e., by scanning the check in the image scanner a second time. In particular, in a retail transaction involving check conversion, if the merchant could make such determination at the point of sale, then the merchant could address the defective image before returning the paper check to the customer. In the non-retail context, the determination should preferably be made before the check is destroyed, so that another attempt to capture a satisfactory (human readable) image can then be made. However, the prior art does not disclose a practical method or system of detecting a failure to obtain a human readable image shortly after the check is scanned in the image scanner.

In U.S. Pat. No. 6,357,553 (Hayosh), a method and apparatus to provide quality assurance for the electronic transfer of document image files is disclosed. The method of that invention involves comparing “first quality assurance data” (i.e., usually entirely magnetically derived MICR data) stored in an “image tag file” with “second quality assurance data” (i.e., MICR line data, obtained by an image character recognition device) stored in an “image data file”. For a particular check, if the MICR data which was obtained generally via the MICR reader agrees with the MICR code line data obtained by image character recognition, then the check is accepted by Hayosh's system.

In accordance with typical practice described in Hayosh, the image tag file and the image data file (after compression) are sent, for example, from one financial institution to another for a batch of checks. Typically, in this procedure the paper check documents are sent later, unlike the procedure under Check 21, which contemplates destruction of paper checks once the checks have been scanned in an image scanner. In the process described in Hayosh, the image data files are compressed before they are sent, and Hayosh particularly addresses concerns about whether the image data files, when decompressed, will provide human readable images. The Hayosh patent discloses a method in which images which may be randomly chosen from the compressed image files to be decompressed. Images of the MICR characters only which are extracted from the decompressed image data are recognized in an OCR device. The data from the image tag file (i.e., primarily magnetically derived MICR data) is then compared to the corresponding data which was recognized in the OCR device.

However, the Hayosh method only determines, apparently on a random basis, whether the images of the MICR characters (extracted after decompression of the image file) are consistent with the magnetically derived MICR data (and possibly other data) from the image tag file. Hayosh does not disclose a method of determining whether human readable images of non-MICR printed characters in other locations on the face of the check have been captured.

For example, the Hayosh invention would not identify an image as unsatisfactory where some of the non-MICR printed characters are obscured or otherwise unsatisfactorily captured, but the MICR line is satisfactorily captured. Where the Hayosh invention can process MICR data and an image of MICR line data for a particular check satisfactorily, such check would be accepted. This is because the Hayosh patent does not address image quality in the upper regions of the check, but only in the “MICR clear band”, a strip ⅝ inch wide across a lower part of the front side, which is usually devoid of dark background patterns.

Also, Hayosh's method will not automatically verify that the image of a check will be human readable when the check is scanned to allow a re-scanning in real time, i.e., Hayosh's method is applied to the image data file after decompression thereof.

At present, no automatic means is available to monitor image data file quality for human readability, and to provide an assurance that a quality digital image of the entire front side of the check has been captured.

There is therefore a need for a system and method for verifying legibility of an image of a check captured in digital image data.

### SUMMARY OF THE INVENTION

In its broad aspect, the invention provides a method for verifying legibility of an image of a check captured in digital image data, the check having two groups of characters on a front side thereof, each said group including at least one character which is a numeric representation of a check serial number for the check, each said group being spaced apart from each other and located in a preselected pattern, the method comprising the steps of:
(a) extracting images of each said group from said digital image data;
(b) recognizing by optical character recognition means said characters in said groups in said images to provide a first image serial number value of said numeric representation in one of said groups and a second serial number value of said numeric representation in another of said groups;
(c) comparing the first serial number value with the second serial number value to determine whether the first serial number value and the second serial number value are identical; and
(d) generating a warning signal if said first serial number value and the second serial number value are not identical.

In another aspect, the invention includes a method including the step of:
(e) generating an acceptance signal if the first serial number value and the second serial number value are identical.

In another aspect, the invention provides a method for verifying legibility of an image of a check captured in digital image data, the check having two groups of characters on a front side thereof, each said group including a set of numeric representations, said set of numeric representations in one of said groups representing fractional FR-ABA data for the check and said set of numeric representations in another of said groups representing a transit routing number for the check, said fractional FR-ABA data being identical to the transit routing number upon said fractional FR-ABA data being subjected to a predetermined rearrangement operation, each of said groups being spaced apart from each other and located in a preselected pattern, the method comprising the steps of:
(a) extracting images of each said group from said digital image data;
(b) recognizing by optical character recognition means said characters in said groups in said images to provide an image value of the transit routing number and an image value of said fractional FR-ABA data respectively;
(c) performing said rearrangement operation on said image value of the fractional FR-ABA data to provide a rearranged image value;
(d) comparing said image value of the transit routing number with said rearranged image value to determine whether said image value of the transit routing number and said rearranged image value are identical; and
(e) generating a warning signal if said image value of the transit routing number and said rearranged image value are not identical.

In another aspect, the invention provides a method including the step of:
(f) generating an acceptance signal if said image value of the transit routing number and said rearranged image value are identical.

In yet another of its aspects, the invention provides a method for verifying legibility of an image of a check captured in digital image data, the check having at least one field of characters thereon, said field including a set of numeric representations representing a transit routing number for the check, said at least one field additionally including a single digit being a check digit verification number for verifying the transit routing number, the check digit verification number being determined by subjecting said transit routing number to predetermined arithmetic operations collectively defined as mod 10, the method comprising the steps of:
(a) extracting images of each said character in said at least one field from said digital image data;
(b) recognizing by optical character recognition means said characters in said images of said transit routing number and said check digit verification number to provide an image value of the transit routing number and an image value of said check digit verification number respectively;
(c) performing said mod 10 operation on said image value of the transit routing number to determine a calculated image value;
(d) comparing said image value of said check digit verification number with the calculated image value to determine whether said image value of said check digit verification number and the calculated image value are identical; and
(e) generating a warning signal if said image value of said check digit verification number and said calculated image value are not identical.

In another aspect, the invention provides a method including the step of:
(f) generating an acceptance signal if said image value of said single digit and said calculated image value are identical.

The invention additionally provides a system for verifying legibility of an image of a check captured in digital image data, the check having two groups of characters on a front side thereof, each said group including at least one character which is a numeric representation of a check serial number for the check, each said group being spaced apart from each other and located in a preselected pattern, the system comprising:
a means for extracting images of each said group from said digital image data;
an optical character reader for recognizing said characters in said two groups in said images to provide a first image serial number value of said numeric representation in one of said two groups and a second image serial number value of said numeric representation in another of said two groups; and
a processor for comparing the first image serial number value with the second image serial number value to determine whether the first image serial number value and second image serial number value are identical, and for generating a warning signal if said first image serial number value and the second image serial number value are not identical.

In another aspect, the invention provides a system for verifying legibility of an image of a check captured in digital image data, the check having two groups of characters on a front side thereof, each said group including a set of numeric representations, said set of numeric representations in one of said groups representing fractional FR-ABA data for the check, and said set of numeric representations in another of said groups representing a transit routing number for the check, said fractional FR-ABA data being identical to the transit routing number being subjected to a predetermined rearrangement operation, each of said groups being spaced apart from each other and located in a preselected pattern, the system comprising:
a means for extracting images of each said group from said digital image data;
an optical character reader for recognizing said characters in said two groups in said images to provide an image value of the transit routing number said set of numeric representations and at least one arranged image value of said fractional FR-ABA data respectively;
a processor for performing said rearrangement operation on said at least one arranged image value to provide at least one rearranged image value, comparing said image value of the transit routing number with said at least one rearranged image value to determine whether said image value of the transit routing number and said at least one rearranged image value are identical, and generating a warning signal if said image value of the transit routing number and said at least one rearranged image value are not identical.

In yet another aspect, the invention provides a system for verifying legibility of an image of a check captured in digital data, the check having at least one field of characters thereon, said at least one field including a set of numeric representations representing a transit routing number for the check, said at least one field additionally including a single digit being a check digit verification number for verifying the transit routing number, the check digit verification number being determined by subjecting said transit routing number to predetermined arithmetic operations collectively defined as mod 10, the system comprising:
a means for extracting images of each said character in said at least one field from said digital image data;
an optical character reader for recognizing said characters in said images of said transit routing number and said check digit verification number to provide an image value of the transit routing number and an image value of said check digit verification number respectively;
a processor for performing said mod 10 operation on said image value of said transit routing number to determine a calculated image value, comparing said image value of said check digit verification number with the calculated image value to determine whether said image value of said check digit verification number and the calculated image value are identical, and generating a warning signal if said image value of said check digit verification number and the calculated image value are not identical.

### BRIEF DESCRIPTION OF THE DRAWINGS

The invention will be better understood with reference to the attached drawings, in which:

FIG. 1A is a view of a front side of a typical check;

FIG. 1B is a view of the front side of the check of FIG. 1A, drawn at a larger scale;

FIG. 2 is a schematic of a preferred embodiment of the system of the invention; and

FIGS. 3A and 3B are flow charts illustrating the operation of the system according to principles of the present invention.

### DETAILED DESCRIPTION OF THE PREFERRED EMBODIMENT(S)

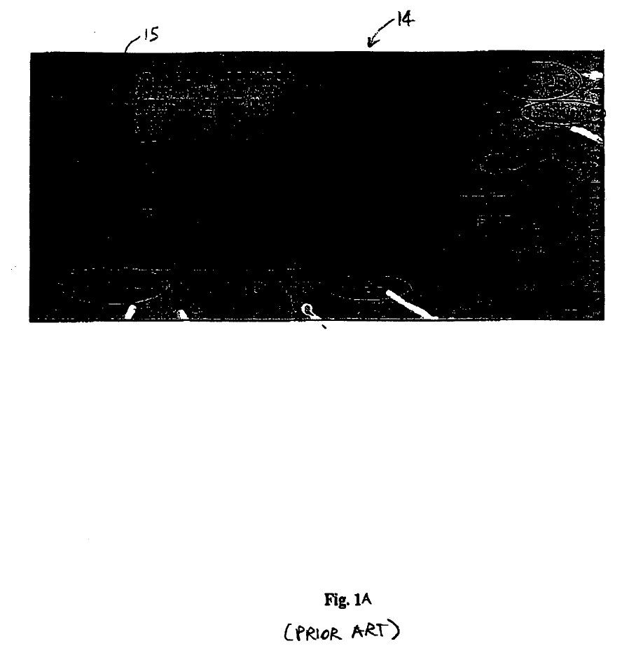

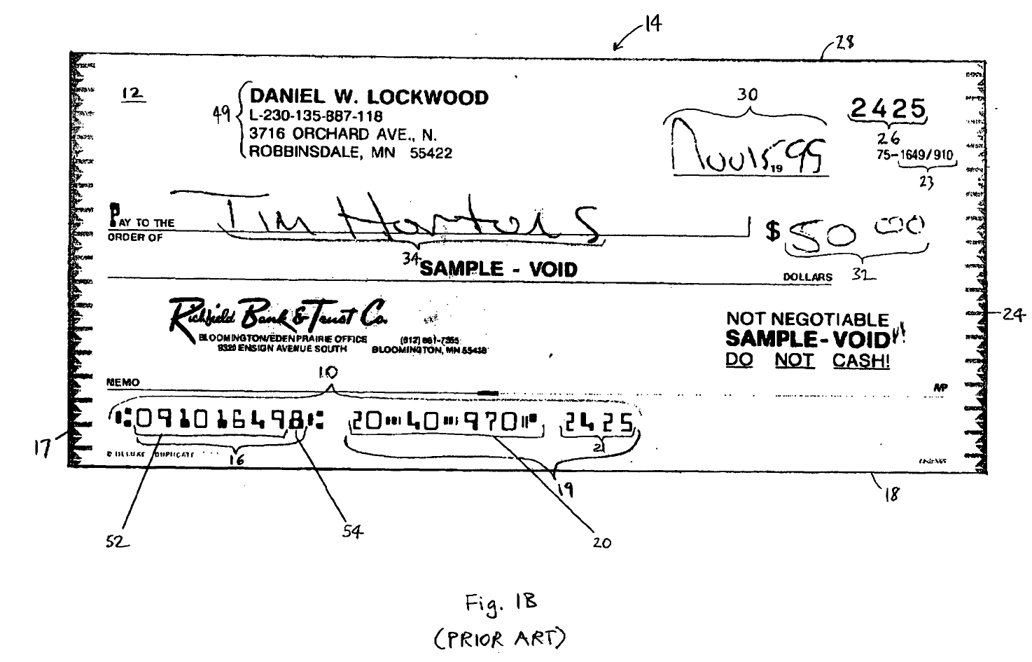

As described above, the grouping and location of MICR characters and non-MICR printed characters on a check are in accordance with certain standards and conventions for that type of check. For simplicity, the description of the invention is limited to examples provided herein with reference to the sample check 14 shown in FIGS. 1A and 1B. The check 14 is a personal check which is compatible for use in the U.S. bank processing system. In such a check, the MICR code line 10 is required to comply with ANSI X9.13, and the locations of the fields of non-MICR printed characters 23, 26 are in accordance with industry standards. As described above, the MICR line 10 includes fields, and the fields can include sub-fields. It will be understood that, for the purposes hereof, a reference to a “group” of characters, whether MICR characters, non-MICR printed characters, or handwritten data, could be a reference to a field, a sub-field, or to some other selected character or collection of characters on the check 14.

Because information is presented on the front side 12 in MICR characters and non-MICR printed characters which are intended to be legible, such information can be captured by optical scanning methods, i.e., scanning a check in an image scanner which creates an image data file 36 of digital image data, which may be stored and processed using electronic means, on which optical character recognition methods can be applied to ascertain numeric values of the fields, and which can be sent electronically. It will be understood that, for the purposes hereof, an image of a particular character is considered to be “legible” if it is legible to a human being, to the extent that such character as shown on the paper check document is legible to a human being. The invention is based on an assumption that if an image of a character is recognizable by optical character recognition methods, then the image is legible.

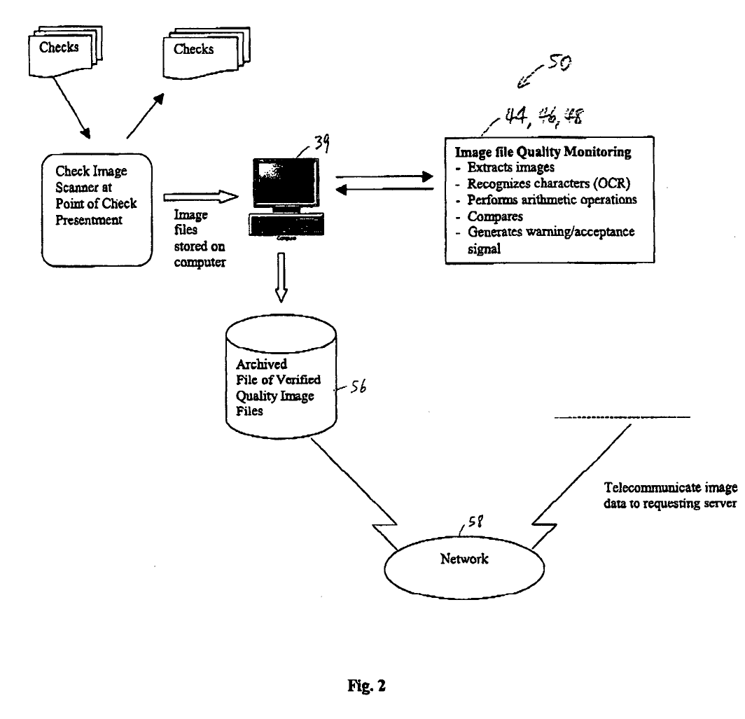

As shown schematically in FIG. 2, the digital image data 36 is stored on a memory device 38, e.g., a memory device included in, or accessible via, a personal computer 39.

In the preferred embodiment of a method of the invention 40, images of each group are first extracted from the digital image data as stored, using a means 44 for extracting the images. For example, images of the sub-field 21 and the field 26 are extracted. Each of the sub-field 21 and the field 26 includes characters which represent a check serial number, e.g., the number “2425” in the sample check 14 (FIGS. 1A and 1B).

The second step in the method of the invention is to recognize, by an optical character recognition (“OCR”) means 46, the characters in the image of the sub-field 21 and in the image of the field 26 to provide a first group numeric value resulting from the image of the sub-field 21 and a second group numeric value resulting from the image of the field 26.

Third, a processor 48 is used to compare the first group numeric value to the second group numeric value. Where the values resulting from optical character recognition of the images of the sub-field 21 and the field 26 are to be compared, such values should be identical. Accordingly, in this case, the first group numeric value and the second group numeric value are compared to determine whether they are identical.

If they are not, the processor 48 generates a first warning signal. Although such a warning signal could take many forms, it would preferably achieve the object of alerting an operator (not shown) to the error sufficiently quickly to enable the error to be corrected promptly. For instance, a dialogue box (not shown) on a computer alerting a human operator (not shown) could be generated, to cause the human operator to cause the check to be sent through the image scanner a second time.

In an alternative embodiment, the method also includes the step of the processor 48 generating an acceptance signal when the first group numeric value and the second group numeric value are identical.

As can be seen in FIG. 1B, the sub-field 21 is located near the bottom edge 18 of the check 14, spaced apart from the right-hand edge 24 a certain distance. The location of the sub-field 21 on the front side 12 is determined according to ANSI X9.13. Also, the field 26 is located adjacent to the top edge 28 and the right-hand edge 24, in accordance with conventional practice. Both the sub-field 21 and the field 26 are therefore spaced apart from each other and located in accordance with a preselected pattern. In particular, because the field 26 is located in the upper right-hand corner, determining that a legible image of that field has been captured provides a reasonable basis for assuming that a legible image of the other information (both non-MICR printed characters and handwritten data) in the upper part of the check 14 was captured.

In its preferred embodiment, the method of the invention proceeds on the basis that determining whether consistent images of two groups of characters that are spaced apart on the front side 12 is a reasonable sampling to justify a conclusion that a legible image of a check has been captured (or not, as the case may be). If, for example, background coloring on the front side 12 resulted in the characters in the field 26 being illegible, then such background coloring could also adversely affect the legibility of other information on the check, such as an account holder's name and address 49 (FIG. 1B), or handwritten data or other non-MICR printed characters. On the other hand, if legible images of the sub-field 21 and the field 26 have been captured, it is assumed that a legible image of the balance of the front side 12 has been captured.

As can be seen in FIGS. 1A and 1B, the MICR characters are presented in a particular font, known as E13B, in accordance with ANSI X9.13. The non-MICR printed characters can be presented in a variety of fonts, e.g., Arial, Times New Roman, etc. For the purposes hereof, all fonts other than E13B are designated “standard fonts”. The characters in the sub-field 21 are MICR characters, and they are therefore presented in E13B font. As shown in FIGS. 1A and 1B, the characters in the field 26 are presented in a standard font.

It therefore can be seen that one advantage of the preferred embodiment of the method of the invention is that the method involves sampling of the image of the front side 12, across substantially the width (i.e., from approximately the bottom edge 18 to approximately the top edge 28) of the entire front side 12. In particular, the invention involves a comparison of an image of characters in the upper region of the check with an image of characters in the lower region (the MICR line). In the preferred embodiment, the method of the invention also advantageously accommodates images of characters which were presented on the check 14 in a variety of fonts, i.e., E13B and one of the standard fonts.

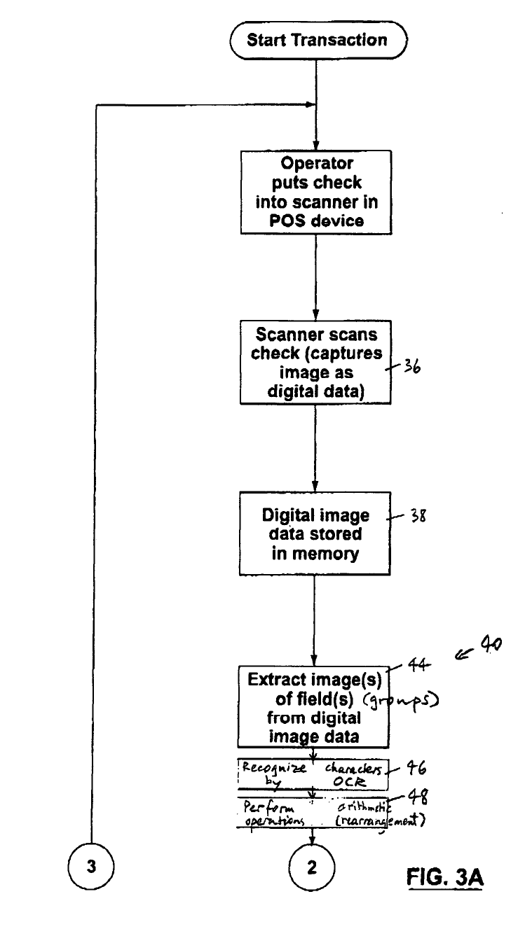

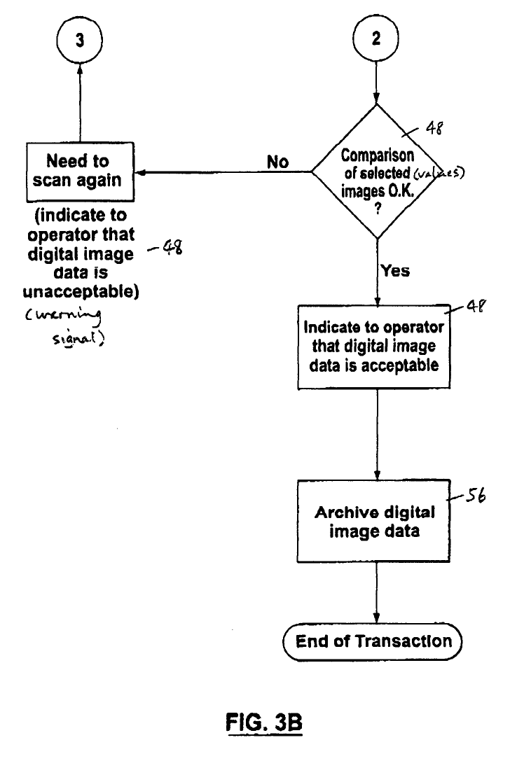

Reference is made to FIGS. 1A, 1B, 2, 3A, and 3B to describe a preferred embodiment of a system 50 for verifying legibility of an image of the check 14 captured in digital image data. As can be seen in FIG. 1B, the check 14 has at least two groups of characters on the front side thereof, for example, the sub-field 21, and the field 26. Each of the sub-field 21 and the field 26 includes one or more characters which are numeric representations. As can be seen in FIG. 1B, and as discussed above, the sub-field 21 and the field 26 are spaced apart from each other and located in a preselected pattern. The system 50 includes the means 44 for extracting images of each of the sub-field 21 and the field 26 from the digital image data. The system 50 also includes the OCR means 46 (or “optical character reader”) for recognizing the characters in the images of the sub-field 21 and the field 26 to provide a first group numeric value of the numeric representation in one of the groups (e.g., the sub-field 21), and a second group numeric value of the numeric representation in the other of the groups (e.g., the field 26). The system 50 also includes the processor 48 for comparing the first group numeric value with the second group numeric value to determine whether the first group numeric value and the second group numeric value are identical. For example, the first group numeric value for the sample check 14 should be “2425” (i.e., the check serial number), if a legible image of the sub-field 21 has been captured, and the second group numeric value should also be “2425”. In the preferred embodiment, the processor 48 is also adapted for generating a warning signal if the first group numeric value and the second group numeric value are not identical.

In an alternative embodiment, the processor 48 is also adapted to generate an acceptance signal if the first group numeric value and the second group numeric value are identical.

In another embodiment of the method of the invention, images of each group are first extracted from the digital image data, using the means 44 for extracting the images. For example, images of a sub-field 52 of the field 16 and the field 23 are extracted. The sub-field 52 includes characters which identify a financial institution, and the branch of the financial institution, on which the check is drawn, and the sub-field 52 is also referred to herein as the “transit routing number”. For example, the first four digits in the sub-field 52 (e.g., “0910”, in the sample check 14) are a federal reserve number, assigned to identify the financial institution on which the check is drawn. The second four digits in the sub-field 52 (e.g., “1649”, in the check 14) identify the particular branch of the financial institution at which the account for the check is located. The field 23 includes characters which are an arranged version of the characters found in the sub-field 52. The characters in the field 23 are also referred to herein as “fractional FR-ABA data”. The fractional FR-ABA data includes the federal reserve number and the branch number, reversed in order (reading left to right) from that in which they are presented in the sub-field 52 and separated by a virgule.

Additional non-MICR printed characters might be positioned adjacent to the field 23. For example, in the check 14, the characters “75-” are also included. These additional characters are internal numbers specific to the financial institution on which the check is drawn, and would be ignored by the method of the invention.

It can be seen from FIGS. 1A and 1B that the fractional FR-ABA data (i.e., “1649/910” in the check 14) can provide the characters in the sub-field 52 (i.e., “09101649” in the check 14) upon the fractional FR-ABA data in the field 23 being subjected to a predetermined rearrangement operation, in which the order of the numbers in the field 23 are reversed, and the virgule is eliminated.

The second step in the method of the invention is to recognize, by the OCR means 46, the characters in the image of the sub-field 52 (i.e., the transit routing number) and in the image of the field 23 to provide an image value of the transit routing number and an image value of the fractional FR-ABA data. In the example of the check 14, if a legible image of the transit routing number has been captured, then the image value of the transit routing number would be “09101649”.

Third, the processor 48 performs the predetermined rearrangement operation on the arranged image value to provide a rearranged image value. For example, in the check 14, the arranged image value of the field 23 should be “1649/910”, and after the rearrangement operation has been performed on that image value, the result (i.e., the “rearranged image value”) would be “09101649”. The processor 48 also compares the image value of the transit routing number with the rearranged image value to determine whether the image value of the transit routing number and the rearranged image value are identical. If they are not, the processor 48 generates a first warning signal. In another embodiment, if the image value of the transit routing number and the rearranged image value are identical, then the processor 48 generates an acceptance signal.

As shown in FIG. 1B, the field of MICR characters 16 includes a single digit 54 (“8”, in the check 14) which is a check digit verification (“CDV”) number, determined by subjecting the characters in the sub-field 52 (i.e., the transit routing number) to predetermined arithmetic operations collectively known as “mod 10” and defined in ANSI X9.13. For example, in the check 14, the transit routing number is “09101649”.

In another embodiment of the method of the invention, the first step is to extract images of the characters in the sub-field 52 and an image of the single digit 54 from the digital image data, using the means 44 for extracting images.

The second step in the method is to recognize, by the OCR means 46, the images of the transit routing number and the single digit 54 (i.e., the CDV number) to provide an image value of the transit routing number and an image value of the check digit verification number respectively.

Third, the processor 48 is used to perform the predetermined arithmetic operations (i.e., mod 10) on the image value of the transit routing number to determine a calculated image value. The processor then compares the image value of the check digit verification number with the calculated image value to determine whether the image value of the check digit verification number and the calculated image value are identical. If they are not, the processor 48 generates the first warning signal. If they are, an acceptance signal is then generated.

This embodiment of the invention would not, if applied alone, provide assurance about the quality of the image for the upper region of the check. However, where the image values of the transit routing number and the fractional FR-ABA data are inconsistent (i.e., as determined using another embodiment of the invention, described above), this embodiment would be useful to determine whether the image value of the transit routing number is correct or not.

From the foregoing, it can be seen that, in general terms, the method of the invention could be said to involve verifying legibility of an image of a check where one or more characters in a first group of characters on the check has a predetermined relationship with one or more characters in a second group of characters on the check. Images of the characters in the first group, and images of the characters in the second group, are subjected to certain operations to determine whether the images of the characters in the first group have the predetermined relationship with the images of the characters in the second group.

For example, in the preferred embodiment, the predetermined relationship between the MICR characters in the sub-field 21 and the non-MICR printed characters in the field 26 is direct: the characters in each field 21, 26 represent the same parameter, namely, a check serial number. In this case, the numeric value recognized for the images of the characters in one field only need to be subtracted from the numeric value recognized for the images of the characters in the other field. If the difference is zero, then the numeric values of the images are identical, and the image of the check in the digital image data is considered to be legible.

As another example, the predetermined relationship between the set of numeric representations which constitutes the sub-field 52 and the single digit 54 is determined by the sequence of arithmetic operations known as mod 10.

In another example, the predetermined relationship between the set of numeric representations which constitutes the sub-field 52 and the set of numeric representations which is included in the field 23 is defined by a sequence of manipulative steps which results in the non-MICR printed characters in the field 23 being an arranged version of the MICR characters in the sub-field 52, i.e., the MICR characters of sub-field 52 are replicated in reverse order in the field 23.

As shown in FIG. 2, once the image in the digital image data has been verified, the digital image data preferably is archived as an archived data file 56. The archived data 56 is accessible for transmission electronically, e.g., via a network 58, as required.

Although the invention is described herein with reference to the sample check shown in FIGS. 1A and 1B, i.e., a personal check which is compatible with the U.S. check processing system, it will be understood that the invention also could be used with other types of checks (e.g., business checks compatible with the U.S. check processing system) and other check processing systems.

It will be appreciated by those skilled in the art that the invention can take many forms, and that such forms are within the scope of the invention as claimed. Therefore, the spirit and scope of the appended claims should not be limited to the descriptions of the preferred versions contained herein.

1. A method for verifying legibility of an image of a check captured in digital image data, the check having two groups of characters on a front side thereof, each said group including at least one character which is a numeric representation of a check serial number for the check, each said group being spaced apart from each other and located in a preselected pattern, the method comprising the steps of:
(a) extracting images of each said group from said digital image data;
(b) recognizing by optical character recognition means said characters in said groups in said images to provide a first image serial number value of said numeric representation in one of said groups and a second serial number value of said numeric representation in another of said groups;
(c) comparing the first serial number value with the second serial number value to determine whether the first serial number value and the second serial number value are identical; and
(d) generating a warning signal if said first serial number value and the second serial number value are not identical.

2. A method according to claim 1 in which one of said groups of characters is located proximal to a lower edge of the check and another of said groups of characters is located proximal to an upper edge of the check.

3. A method according to claim 1 in which said at least one character included in one of said groups is presented on the check in a first font and said at least one character included in another of said groups is presented on the check in a second font which is materially different from said first font.

4. A method according to claim 1 in which one of said groups comprises MICR characters representing the check serial number and in which another of said groups comprises non-MICR printed characters representing the check serial number.

5. A method according to claim 4 in which said MICR characters are presented on the check in E13B font and in which said non-MICR printed characters are presented on the check in a standard font.

6. A method according to claim 1 additionally including the step of:
(e) generating an acceptance signal if the first serial number value and the second serial number value are identical.

7. A method for verifying legibility of an image of a check captured in digital image data, the check having two groups of characters on a front side thereof, each said group including a set of numeric representations, said set of numeric representations in one of said groups representing fractional FR-ABA data for the check and said set of numeric representations in another of said groups representing a transit routing number for the check, said fractional FR-ABA data being identical to the transit routing number upon said fractional FR-ABA data being subjected to a predetermined rearrangement operation, each of said groups being spaced apart from each other and located in a preselected pattern, the method comprising the steps of:
(a) extracting images of each said group from said digital image data;
(b) recognizing by optical character recognition means said characters in said groups in said images to provide an image value of the transit routing number and an image value of said fractional FR-ABA data respectively;
(c) performing said rearrangement operation on said image value of the fractional FR-ABA data to provide a rearranged image value;
(d) comparing said image value of the transit routing number with said rearranged image value to determine whether said image value of the transit routing number and said rearranged image value are identical; and
(e) generating a warning signal if said image value of the transit routing number and said rearranged image value are not identical.

8. A method according to claim 7 in which one of said two groups of characters is located proximal to a lower edge of the check and another of said two groups of characters is located proximal to an upper edge of the check.

9. A method according to claim 7 in which said fractional FR-ABA data is presented on the check in a first font and said transit routing number is presented on the check in a second font which materially differs from the first font.

10. A method according to claim 7 in which said fractional FR-ABA data is presented in non-MICR printed characters in a standard font and said transit routing number is presented in MICR characters in E13B font.

11. A method according to claim 7 additionally including the step of:
(f) generating an acceptance signal if said image value of the transit routing number and said rearranged image value are identical.

12. A method for verifying legibility of an image of a check captured in digital image data, the check having at least one field of characters thereon, said field including a set of numeric representations representing a transit routing number for the check, said at least one field additionally including a single digit being a check digit verification number for verifying the transit routing number, the check digit verification number being determined by subjecting said transit routing number to predetermined arithmetic operations collectively defined as mod 10, the method comprising the steps of:
(a) extracting images of each said character in said at least one field from said digital image data;
(b) recognizing by optical character recognition means said characters in said images of said transit routing number and said check digit verification number to provide an image value of the transit routing number and an image value of said check digit verification number respectively;
(c) performing said mod 10 operation on said image value of the transit routing number to determine a calculated image value;
(d) comparing said image value of said check digit verification number with the calculated image value to determine whether said image value of said check digit verification number and the calculated image value are identical; and
(e) generating a warning signal if said image value of said check digit verification number and said calculated image value are not identical.

13. A method according to claim 12 additionally including the step of:
(f) generating an acceptance signal if said image value of said single digit and said calculated image value are identical.

14. A system for verifying legibility of an image of a check captured in digital image data, the check having two groups of characters on a front side thereof, each said group including at least one character which is a numeric representation of a check serial number for the check, each said group being spaced apart from each other and located in a preselected pattern, the system comprising:
a means for extracting images of each said group from said digital image data;
an optical character reader for recognizing said characters in said two groups in said images to provide a first image serial number value of said numeric representation in one of said two groups and a second image serial number value of said numeric representation in another of said two groups; and
a processor for comparing the first image serial number value with the second image serial number value to determine whether the first image serial number value and second image serial number value are identical, and for generating a warning signal if said first image serial number value and the second image serial number value are not identical.

15. A system according to claim 14 in which one of said two groups of characters is located proximal to a lower edge of the check and another of said two groups of characters is located proximal to an upper edge of the check and said means for extracting images is adapted to extract images of each said group from said digital image data.

16. A system according to claim 14 in which said at least one character included in one of said two groups is presented on the check in a first font and said at least one character included in another of said two groups is presented on the check in a second font which is materially different from the first font, and in which the optical character reader is adapted to recognize the first and second fonts.

17. A system according to claim 14 in which the processor is further adapted to generate an acceptance signal if the first image serial number value and the second image serial number value are identical.

18. A system for verifying legibility of an image of a check captured in digital image data, the check having two groups of characters on a front side thereof, each said group including a set of numeric representations, said set of numeric representations in one of said groups representing fractional FR-ABA data for the check, and said set of numeric representations in another of said groups representing a transit routing number for the check, said fractional FR-ABA data being identical to the transit routing number being subjected to a predetermined rearrangement operation, each of said groups being spaced apart from each other and located in a preselected pattern, the system comprising:
a means for extracting images of each said group from said digital image data;
an optical character reader for recognizing said characters in said two groups in said images to provide an image value of the transit routing number said set of numeric representations and at least one arranged image value of said fractional FR-ABA data respectively;
a processor for performing said rearrangement operation on said at least one arranged image value to provide at least one rearranged image value, comparing said image value of the transit routing number with said at least one rearranged image value to determine whether said image value of the transit routing number and said at least one rearranged image value are identical, and generating a warning signal if said image value of the transit routing number and said at least one rearranged image value are not identical.

19. A system according to claim 18 in which the processor is further adapted to generate an acceptance signal if said image value of the transit routing number and said at least one rearranged image value are identical.

20. A system for verifying legibility of an image of a check captured in digital data, the check having at least one field of characters thereon, said at least one field including a set of numeric representations representing a transit routing number for the check, said at least one field additionally including a single digit being a check digit verification number for verifying the transit routing number, the check digit verification number being determined by subjecting said transit routing number to predetermined arithmetic operations collectively defined as mod 10, the system comprising:
a means for extracting images of each said character in said at least one field from said digital image data;
an optical character reader for recognizing said characters in said images of said transit routing number and said check digit verification number to provide an image value of the transit routing number and an image value of said check digit verification number respectively;
a processor for performing said mod 10 operation on said image value of said transit routing number to determine a calculated image value, comparing said image value of said check digit verification number with the calculated image value to determine whether said image value of said check digit verification number and the calculated image value are identical, and generating a warning signal if said image value of said check digit verification number and the calculated image value are not identical.

21. A system according to claim 20 in which the processor is further adapted to generate an acceptance signal if said image value of said check digit verification number and the calculated image value are identical.
